(19) United States
(12) Patent Application Publication
(10) Pub. No.: US 2024/0021790 A1
(43) Pub. Date: Jan. 18, 2024

(54) Anode Material For Lithium Ion Secondary Battery, Preparation Method Therefor, And Lithium Ion Secondary Battery Comprising Same

(71) Applicant: DAEJOO ELECTRONIC MATERIALS CO., LTD., Gyeonggi-do (KR)

(72) Inventors: Jong Chan Lim, Gyeonggi-do (KR); Hyun Hee Lim, Gyeonggi-do (KR)

(73) Assignee: DAEJOO ELECTRONIC MATERIALS CO., LTD., Gyeonggi-do (KR)

(21) Appl. No.: 18/257,999

(22) PCT Filed: Dec. 10, 2021
(86) PCT No.: PCT/KR2021/018744

§ 371 Date: Sep. 20, 2023

(30) Foreign Application Priority Data
Dec. 17, 2020 (KR) 10-2020-0177559

(51) Int. Cl. H01M 4/36; H01M 4/38; H01M 4/587; H01M 10/0525; C01B 32/963; C01B 33/029

(52) U.S. Cl. CPC H01M 4/364; H01M 4/386; H01M 4/587; H01M 4/366; H01M 10/0525; C01B 32/963; C01B 33/029; H01M 2004/027

(57) ABSTRACT

An embodiment of the present invention relates to: an anode material for a lithium ion secondary battery, comprising a silicon-silicon carbide composite; a preparation method therefor; and a lithium ion secondary battery comprising same, and, more specifically, the anode material for a lithium ion secondary battery, according to the embodiment, is an anode material, which comprises a silicon-silicon carbide composite containing silicon particles and silicon carbide particles, wherein the silicon particles and the silicon carbide particles in the silicon-silicon carbide composite are dispersed from each other and the amount of the silicon carbide particles satisfies a specific range, and thus high capacity and excellent cycle characteristics can be implemented while a low volume expansivity is maintained.

### TECHNICAL FIELD

The present invention relates to a negative electrode material for lithium-ion secondary batteries, comprising a silicon-silicon carbide composite, to a process for preparing the same, and to a lithium-ion secondary battery comprising the same.

### BACKGROUND ART

In recent years, in tandem with the development of portable electronic devices and communication devices, the demand for a higher energy density of secondary batteries is increased from the viewpoint of economic efficiency, smaller size, and lighter weight of devices.

As a method for increasing the capacity of such secondary batteries, a variety of methods, for example, a method of using oxides of V, Si, B, Zr, or Sn, and composite oxides thereof, a method of using a metal oxide rapidly cooled in molten metal, or a method of using silicon oxide, as a negative electrode active material, have been used.

Among the above, Japanese Patent No. 2997741 discloses a high-capacity electrode using silicon oxide as a negative electrode material for lithium-ion secondary batteries. However, a secondary battery comprising the electrode has low initial efficiency and has limitations in achieving satisfactory cycle characteristics. In addition, although the predoping of lithium as a negative electrode material or the addition of a metal having a high reducing power such as aluminum has been attempted in order to enhance the initial efficiency of a secondary battery, there may be a problem in that the capacity of the secondary battery decreases.

In addition, Japanese Patent No. 4393610 discloses a method of coating a carbon layer on the surface of silicon oxide particles by chemical vapor deposition for the purpose of imparting conductivity to a negative electrode material. In such a case, however, while the cycle characteristics of a secondary battery are enhanced, there may be a problem in that the capacity gradually decreases as the number of cycles of charging and discharging is repeated due to the precipitation of fine silicon crystals and insufficient fusion with the structure of the carbon coating and the substrate.

Therefore, research on negative electrode materials for lithium-ion secondary batteries and their preparation methods, which can enhance the initial charge and discharge efficiency and cycle characteristics of secondary batteries while maintaining the advantages of silicon-based high battery capacity and low volume expansion, is continuously required.

### PRIOR ART DOCUMENTS

### Patent Documents

(Patent document 1) Japanese Patent No. 2997741
(Patent document 2) Japanese Patent No. 4393610

### DISCLOSURE OF INVENTION

### Technical Problem

The present invention is devised to solve the above problems of the prior art.

An object of the present invention is to provide a negative electrode material for a lithium-ion secondary battery, which can simultaneously implement high capacity and excellent cycle characteristics while maintaining a low volume expansion rate, in which silicon particles and silicon carbide particles are dispersed with each other in a silicon-silicon carbide composite comprising the silicon particles and silicon carbide particles, and the content of the silicon carbide particles satisfies a specific range.

Another object of the present invention is to provide a process for preparing a negative electrode material for a lithium-ion secondary battery that can be mass-produced by a simple method.

Still another object of the present invention is to provide a lithium-ion secondary battery, which comprises the negative electrode material for a lithium-ion secondary battery.

### Solution to Problem

The present invention provides a negative electrode material for a lithium-ion secondary battery, which comprises a silicon-silicon carbide composite comprising silicon particles and silicon carbide particles, wherein the silicon particles and the silicon carbide particles are dispersed with each other in the silicon-silicon carbide composite, the silicon carbide particles are employed in an amount of 10% by weight to 80% by weight based on the total weight of the silicon-silicon carbide composite, and a carbon film is formed on the surface of the silicon-silicon carbide composite.

In addition, the present invention provides a process for preparing the negative electrode material for a lithium-ion secondary battery, which comprises (1) thermally decomposing a silicon source gas and a hydrocarbon gas in an inert gas atmosphere at 1,000° C. to 1,500° C. to obtain a thermal decomposition product; (2) depositing the thermal decomposition product as a solid on a precipitation plate to obtain a silicon-silicon carbide composite; and (3) forming a carbon film on the surface of the silicon-silicon carbide composite.

Further, the present invention provides a lithium-ion secondary battery, which comprises a negative electrode material for a lithium-ion secondary battery.

### Advantageous Effects of Invention

The negative electrode material for a lithium-ion secondary battery of the present invention can simultaneously implement high capacity and excellent cycle characteristics while maintaining a low volume expansion rate as silicon particles and silicon carbide particles are dispersed with each other in a silicon-silicon carbide composite comprising the silicon particles and silicon carbide particles, and the content of the silicon carbide particles satisfies a specific range.

In addition, the preparation process according to the embodiment has an advantage in that production on an industrial scale is possible through a simple method.

### BEST MODE FOR CARRYING OUT THE INVENTION

The present invention is not limited to what is disclosed below. Rather, it may be modified in various forms as long as the gist of the invention is not altered.

In this specification, when a part is referred to as “comprising” an element, it is to be understood that the part may comprise other elements as well, unless otherwise indicated.

In addition, all numbers and expressions related to the quantities of components, reaction conditions, and the like used herein are to be understood as being modified by the term “about,” unless otherwise indicated.

Hereinafter, the present invention will be described in detail.

[Negative Electrode Material for a Lithium-Ion Secondary Battery]

The negative electrode material for a lithium-ion secondary battery according to an embodiment of the present invention comprises a silicon-silicon carbide composite comprising silicon particles and silicon carbide particles, wherein the silicon particles and the silicon carbide particles are dispersed with each other in the silicon-silicon carbide composite, the silicon carbide particles are employed in an amount of 10% by weight to 80% by weight based on the total weight of the silicon-silicon carbide composite, and a carbon film is formed on the surface of the silicon-silicon carbide composite.

The negative electrode material for a lithium-ion secondary battery according to an embodiment can implement high capacity and excellent cycle characteristics while maintaining a low volume expansion rate as silicon particles and silicon carbide particles are dispersed with each other in a silicon-silicon carbide composite comprising the silicon particles and silicon carbide particles, and the content of the silicon carbide particles satisfies a specific range. Further, it is possible to maintain an electrical contact between the composite particles by forming a carbon film on the surface of the silicon-silicon carbide composite, whereby the performance of a lithium-ion secondary battery can be further enhanced.

Hereinafter, the silicon-silicon carbide composite will be described in detail.

[Silicon-Silicon Carbide Composite]

The silicon-silicon carbide composite according to an embodiment of the present invention comprises silicon particles and silicon carbide particles, and the silicon particles and the silicon carbide particles are dispersed with each other in the silicon-silicon carbide composite.

The silicon-silicon carbide composite may have a firm structure in which silicon particles and silicon carbide particles are uniformly distributed with each other in a matrix that comprises them.

When a large amount of lithium is occluded and released during repeated charging and discharging of a lithium-ion secondary battery, it is possible, by virtue of such a structure, to prevent or suppress the pulverization of the composite caused by a large volume change of silicon particles (e.g., about 400%), thereby suppressing the destruction of the composite. In addition, side reactions between the silicon particles and the electrolyte may be prevented or minimized. In addition, it is possible to prevent in advance that the silicon particles expand in volume due to the occlusion of lithium, which otherwise decreases the conductivity and hinders the movement of lithium-ions in the electrode, and to reduce the initial irreversible capacity due to the production of lithium oxide (Li₂O).

In addition, the present invention is characterized in that, according to an embodiment, the silicon carbide particles in the silicon-silicon carbide composite are employed in an amount of 10% by weight to 80% by weight based on the total weight of the silicon-silicon carbide composite.

As the content of the silicon carbide particles in the silicon-silicon carbide composite satisfies the above specific content range, high cycle characteristics and charge and discharge capacity of a lithium-ion secondary battery can be achieved.

Further, according to an embodiment of the present invention, a carbon film is formed on the surface of the silicon-silicon carbide composite. As a result, it is possible to maintain or enhance an electrical contact between the composite particles, while maintaining the external shape of the silicon-silicon carbide composite, whereby the performance of a lithium-ion secondary battery can be further enhanced.

Meanwhile, when a negative electrode material comprising the silicon-silicon carbide composite comprising silicon particles and silicon carbide particles is used, a solid electrolyte interphase (SEI) layer, which is a non-conductive side reaction product layer, may be thickly formed on the surface of the negative electrode material during charging and discharging due to a continuous reaction with an electrolyte. The negative electrode material may be electrically shorted within the electrode due to the formation of a side reaction product layer, resulting in a problem of a decrease in lifespan characteristics and a further increase in volume expansion of the electrode.

Thus, it is necessary to reduce the reactivity between a negative electrode material and an electrolyte to minimize the formation of a side reaction product layer that may be formed on the surface of the negative electrode material. For this purpose, it is necessary to control the content of oxygen present on the surface of the silicon particles.

Meanwhile, silicon carbide particles may be present on the surface of the silicon particles. If no silicon carbide particles are present on the surface of the silicon particles, a natural film having a high oxygen fraction is easily formed. For this purpose, it is preferable to control the molar ratio (0/Si) of oxygen atoms to silicon atoms to 0.01 to 0.1.

As the molar ratio (0/Si) of oxygen atoms to silicon atoms decreases, the initial capacity or cycle characteristics of a lithium-ion secondary battery may be enhanced. In general, as the ratio of oxygen decreases in a negative electrode material comprising silicon, high charge and discharge capacity may be achieved, whereas the volume expansion rate due to charging may be increased. On the other hand, as the ratio of oxygen increases, the volume expansion rate may be suppressed, whereas the charge and discharge capacity may be decreased.

The molar ratio (0/Si) of oxygen atoms to silicon atoms may preferably be 0.01 to 0.05, more preferably 0.01 to 0.02.

Hereinafter, each component of the silicon-silicon carbide composite will be described in detail.

Silicon Particles

The silicon-silicon carbide composite according to an embodiment of the present invention comprises silicon particles.

As the silicon-silicon carbide composite comprises silicon particles, a negative electrode having high capacity and excellent initial efficiency and cycle characteristics can be obtained when it is used as a negative electrode material for a lithium-ion secondary battery capable of occluding and releasing lithium-ions.

Silicon particles contained in the silicon-silicon carbide composite according to an embodiment of the present invention may cause large volume expansion and contraction when lithium is occluded and released. In order to mitigate the stress due to volume expansion and contraction, it is preferable to uniformly distribute the particles in a matrix comprising the silicon particles and the silicon carbide particles.

Although it is necessary to contain silicon as the silicon particles, the reason why a silicon phase is essential is that the capacity of a lithium-ion secondary battery is not developed unless a silicon phase is present, because silicon charges and discharges lithium. The silicon particles are preferably particles having a small crystallite size: for, the volume expansion and contraction during charging and discharging are small, and the performance of a lithium-ion secondary battery can be enhanced.

When the silicon-silicon carbide composite according to an embodiment of the present invention is subjected to an X-ray diffraction (Cu-Kα) analysis using copper as a cathode target and calculated by the Scherrer equation based on a full width at half maximum (FWHM) of the diffraction peak of Si (110) around 20=28.4°, the silicon particles may have a crystallite size of 1 nm to 15 nm, preferably, 1 nm to 8 nm, more preferably, 1 nm to 5 nm.

If the crystallite size of the silicon particles is less than 1 nm, the charge and discharge capacity of a lithium-ion secondary battery may decrease. In addition, since the reactivity becomes high, there may be a case in which a change in properties takes place during storage, making it difficult to prepare a negative electrode slurry during the fabrication of electrodes. If the crystallite size of the silicon particles exceeds 15 nm, cracks may be formed in the silicon-silicon carbide composite due to volume expansion and contraction during the charging and discharging of a lithium-ion secondary battery, thereby deteriorating the cycle characteristics.

Since the silicon particles are not in an amorphous state, there is a low possibility that a region that does not contribute to charging and discharging is generated; thus, it is possible to suppress a reduction in the Coulombic efficiency that stands for the ratio of charge capacity to discharge capacity.

If the crystallite size of the silicon particles is 1 nm or more, there is little concern that the charge and discharge capacity will be reduced. If the crystallite size of the silicon particles is 15 nm or less, there is a low possibility that a region that does not contribute to discharging is generated; thus, it is possible to suppress a reduction in the Coulombic efficiency that stands for the ratio of charge capacity to discharge capacity.

In addition, when the silicon particles are further pulverized, it preferably forms a lithium alloy having a large specific surface area to thereby suppress the destruction of the bulk. The silicon particles react with lithium during charging to form Li_{4.2}Si and return to silicon during discharging.

In such an event, when X-ray diffraction is frequently performed on the silicon particles, the silicon shows a broad pattern, and its structure may be changed to amorphous silicon.

If the crystallite size of the silicon particles is 15 nm or less, when the composite is adopted in a negative electrode material for a lithium-ion secondary battery using a non-aqueous electrolyte, the change in volume during charging and discharging is suppressed, which mitigates the stress at the grain boundary; thus, high initial efficiency and battery capacity can be maintained.

If the silicon particles are further pulverized to have a crystallite size of about 1 nm to 5 nm, the density of the silicon-silicon carbide composite increases, whereby it may approach a theoretical density, and pores may be remarkably reduced. As a result, the density of the matrix is enhanced, and the strength is fortified to prevent cracking; thus, the initial efficiency or cycle lifespan characteristics of a lithium-ion secondary battery may be further enhanced.

The content of silicon (Si) in the silicon-silicon carbide composite may be 30% by weight to 80% by weight, preferably, 40% by weight to 70% by weight, more preferably, 40% by weight to 60% by weight, based on the total weight of the silicon-silicon carbide composite.

If the content of silicon (Si) is less than 30% by weight, the amount of an active material for occlusion and release of lithium is small, which may reduce the charge and discharge capacity of a lithium-ion secondary battery. On the other hand, if it exceeds 80% by weight, the charging and discharge capacity of a lithium-ion secondary battery may be increased, whereas the expansion and contraction of the electrode during charging and discharging may be excessively increased, and the negative electrode material powder may be further pulverized, which may deteriorate the cycle characteristics.

Silicon Carbide Particles

The silicon-silicon carbide composite according to an embodiment of the present invention comprises silicon carbide particles.

The silicon carbide particles contained in the silicon-silicon carbide composite may be amorphous, crystalline, or a combination thereof. The silicon carbide particles may be formed to surround the silicon particles.

The silicon carbide particles may have a crystallite size of 1 nm to 50 nm, specifically, 1 nm to 20 nm. If the crystallite size of the silicon carbide particles satisfies the above range, the formation of cracks due to the volume expansion of the silicon particles during charging and discharging may be mitigated.

In addition, the charge and discharge capacity of a negative electrode may be controlled by the content of the silicon carbide particles contained in the silicon-silicon carbide composite.

The content of the silicon carbide particles may be 10% by weight to 80% by weight, preferably, 20% by weight to 60% by weight, more preferably, 20% by weight to 40% by weight, based on the total weight of the silicon-silicon carbide composite.

If the content of the silicon carbide particles in the silicon-silicon carbide composite is less than 10% by weight, the effect of enhancement in cycle characteristics may be insignificant when the composite is applied to a lithium-ion secondary battery. If the content of the silicon carbide particles in the silicon-silicon carbide composite exceeds 80% by weight, the high charge and discharge capacity of a lithium-ion secondary battery cannot be achieved. In addition, if the content of the silicon carbide particles is excessively large, it may act as a diluent that lowers the capacity.

The silicon carbide particles are ceramics that have electrical conductivity and do not store lithium. For this reason, if the content of the silicon carbide particles is too low, the conductivity of a negative electrode material may be lowered, and the movement of lithium may be hindered.

If the content of the silicon carbide particles is within the above range, a negative electrode material having high conductivity can be obtained. In addition, silicon carbide particles having a diamond structure show a crystalline structure; thus, a diffraction line appears at 2θ=34° to 37° in an X-ray diffraction (Cu-Kα) analysis.

The content of the silicon carbide particles can be adjusted by selecting the type of hydrocarbon, reaction time, and reaction temperature during thermal decomposition chemical vapor deposition (CVD) in the process of preparing the silicon-silicon carbide composite of the present invention. In addition, in order to obtain silicon carbide having high electrical conductivity, nitrogen may be used with a hydrocarbon. The content of the silicon carbide particles can be measured using a combustion-infrared absorption method, for example, a carbon analyzer manufactured by HORIBA.

In addition, since the silicon carbide particles are in a state in which silicon and carbon are chemically covalently bonded, cracking of the particles can be prevented. The full width at half maximum (FWHM) of the peak corresponding to the silicon carbide is to 1°, for example, 0.3° to 0.5°. If the full width at half maximum is within the above range, the silicon carbide particles may be crystalline and may impart excellent capacity and conductivity.

Meanwhile, the silicon carbide particles may be amorphous. If the silicon carbide particles are amorphous, the lifespan characteristics, particularly high-temperature cycle lifespan characteristics, of a lithium-ion secondary battery can be further enhanced.

The silicon carbide particles may comprise carbon in the form of silicon carbide and free carbon.

The free carbon may be contained inside the silicon carbide particles.

Specifically, the free carbon may be present in the silicon carbide particles or may be present as dispersed in the silicon-silicon carbide composite together with the silicon particles and the silicon carbide particles. Alternatively, it may be present in both of them. For example, the silicon carbide particles together with the free carbon may form a matrix to surround the silicon particles.

The weight ratio of carbon in the form of silicon carbide and free carbon may be 1:0.02 to 0.3. In the composite according to an embodiment of the present invention, the content of carbon may be measured by a carbon measurement method commonly used in the ceramic field. For example, a combustion-infrared absorption method carbon analyzer is used in accordance with JIS R 2011: 2007. The content of the entire carbon is measured by adding tin powder as a combustion aid, and the content of free carbon is measured without adding a combustion aid. That is, the difference between the content of the entire carbon measured with the addition of a combustion aid and the content of free carbon without the addition of a combustion aid may account for carbon in the form of silicon carbide. The carbon may be classified into free carbon and carbon in the form of silicon carbide.

Carbon Film

In addition, in the silicon-silicon carbide composite, a carbon film is formed on the surface of the silicon-silicon carbide composite. In particular, if carbon is uniformly coated over the entire surface of the silicon-silicon carbide composite to form a carbon layer, an electrical contact between the particles of the composite can be maintained.

It is necessary to reduce the reactivity between the negative electrode material and the electrolyte, minimize the formation of a side reaction product layer that may be formed on the surface of the negative electrode material, and reduce the collapse of the silicon-silicon carbide composite accompanying charging and discharging. In the present invention, it has been discovered that the above effects can be produced by forming a carbon film on the surface of the silicon-silicon carbide composite.

Specifically, it is preferable that the carbon film formed on the surface of the silicon-silicon carbide composite is relatively thin and uniform in conformation to the external shape of the composite. As the carbon film is formed thinly and uniformly, an electrical contact between the particles may be maintained or enhanced while maintaining the external shape of the silicon-silicon carbide composite.

If the thickness of the carbon film is uniform, the stress generated in the carbon film accompanying the volume expansion of the composite during the charging and discharging of a lithium-ion secondary battery can be uniformly relieved in all directions, thereby preventing the destruction of the carbon film. As a result, the cycle characteristics of the lithium-ion secondary battery can be enhanced.

The content of carbon (C) contained in the carbon film may be 2% by weight to 25% by weight, preferably, 3% by weight to 15% by weight, more preferably, 3% by weight to 10% by weight, based on the total weight of the silicon-silicon carbide composite comprising the carbon film

If the content of carbon (C) is less than 2% by weight, a sufficient effect of enhancing conductivity cannot be achieved, and the electrode lifespan of a lithium-ion secondary battery may be deteriorated. If the carbon content exceeds 25% by weight, the discharge capacity of a lithium-ion secondary battery is reduced, making it difficult to achieve high energy, which is not preferable. In addition, the charge and discharge capacity per unit volume may be decreased due to a reduction in the amount of the negative electrode or a reduction in the bulk density.

On the other hand, if the content of carbon (C) is within the above range, electrical conductivity can be further enhanced, and initial charge and discharge efficiency and cycle lifespan characteristics can be further enhanced.

The carbon film may have an average thickness of 1 nm to 300 nm, preferably, 5 nm to 200 nm, more preferably, 10 nm to 150 nm. If the thickness of the carbon film is 1 nm or more, an enhancement in conductivity may be achieved. If it is 300 nm or less, a decrease in the capacity of a lithium-ion secondary battery may be suppressed.

The average thickness of the carbon film may be measured, for example, by the following procedure.

First, a negative electrode material is observed at an arbitrary magnification by a transmission electron microscope (TEM). The magnification is preferably, for example, a degree that can be confirmed with the naked eye. Subsequently, the thickness of the carbon layer is measured at arbitrary 15 points. In such an event, it is preferable to select the measurement positions at random widely as much as possible, without concentrating on a specific region. Finally, the average value of the thicknesses of the carbon layer at the 15 points is calculated.

The carbon layer may comprise at least one selected from graphene, reduced graphene oxide, a carbon nanotube, a carbon nanofiber, and graphite. Specifically, it may comprise graphene.

The silicon-silicon carbide composite having the carbon film may have a specific surface area (Brunauer-Emmett-Teller method; BET) of 3 m²/g to 10 m²/g, preferably, 4 m²/g to 10 m²/g, more preferably, 4 m²/g to 8 m²/g.

If the specific surface area of the silicon-silicon carbide composite having the carbon film is less than 3 m²/g, the rate characteristics of a lithium-ion secondary battery are reduced, which is not preferable. Meanwhile, if the specific surface area of the silicon-silicon carbide composite having the carbon film exceeds 10 m²/g, the contact area with the electrolyte increases, which may expedite a decomposition reaction of the electrolyte or cause a side reaction, which is not preferable.

Meanwhile, the specific surface area (surface area per unit mass) of the silicon-silicon carbide composite is understood to have an impact on whether a component that causes irreversible capacity is formed during the first charge and discharge of a secondary battery. That is, if the specific surface area of the silicon-silicon carbide composite having the carbon film is 3 m²/g to 10 m²/g, the formation of a component that causes irreversible capacity can be suppressed. If the specific surface area is 10 m²/g or less, the initial efficiency of a lithium-ion secondary battery can be enhanced. If the specific surface area is 8 m²/g or less, the initial efficiency of a lithium-ion secondary battery can be further enhanced.

The silicon-silicon carbide composite having the carbon film may have a specific gravity (true specific gravity) of 1.8 g/cm³ to 2.5 g/cm³, preferably, 2.0 g/cm³ to 2.5 g/cm³.

The specific gravity may vary according to the coating amount of carbon. For example, when the amount of carbon is fixed, the pores in the composite are reduced when the specific gravity is high. Thus, when the composite is used as a negative electrode material, the strength of the matrix is strengthened, whereby the initial efficiency or cycle lifespan characteristics of a lithium-ion secondary battery can be enhanced. If the specific gravity of the silicon-silicon carbide composite having the carbon film is within the above range, excellent battery capacity of about 900 mAh/g to 3,000 mAh/g may be achieved, along with enhanced Coulombic efficiency. In addition, even when used in combination with graphite-based materials having low volume expansion, the silicon particles do not cause large volume expansion, thereby causing little separation between the graphite materials and the silicon particles; thus, a lithium-ion secondary battery with excellent cycle characteristics can be obtained.

If the specific gravity of the silicon-silicon carbide composite having the carbon film is 1.8 g/cm³ or more, the dissociation between the negative electrode material powder due to the volume expansion of the negative electrode material during charging may be prevented, and the cycle deterioration may be suppressed. If the specific gravity is 2.5 g/cm³ or less, the impregnability of an electrolyte is enhanced, which increases the utilization rate of the negative electrode material, so that the initial charge and discharge capacity can be enhanced.

If the specific gravity is within the above range, the reaction rate between the silicon-silicon carbide composite and lithium can be within a desired range, and lithium can be appropriately intercalated into the silicon particles in the composite. Thus, the cycle characteristics of a lithium-ion secondary battery can be further enhanced, which is preferable.

Specific gravity may refer to true specific gravity, density, or true density. According to an embodiment of the present invention, for the measurement of specific gravity, for example, for the measurement of specific gravity by a dry density meter, Acupick 111340 manufactured by Shimadzu Corporation may be used as a dry density meter. The purge gas to be used may be helium gas, and the measurement may be carried out after 200 times of purge in a sample holder set at a temperature of 23° C.

Meanwhile, according to an embodiment of the present invention, once a silicon-silicon carbide composite in which a uniform carbon film (hereinafter, referred to as a first carbon film) is formed on the surface of the composite is prepared, an additional carbon film (hereinafter, referred to as a second carbon film) may be formed thinly and uniformly on the surface of the composite), thereby forming a carbon film having a so-called dual structure.

The carbon film is preferably formed of at least one selected from graphite, graphene, reduced graphene oxide, and graphene oxide as a main component. In particular, the reduced graphene oxide is preferable since it can achieve high productivity and high electrical conductivity.

In addition, if a carbon film is uniformly formed on the surface of the silicon-silicon carbide composite, there is an effect of preventing each of the silicon particles and the silicon carbide particles from being exposed to the outside.

The so-called double-structured carbon film may be formed by, for example, repeatedly carrying out carbon deposition several times. If the so-called double-structured carbon film is formed, an electrical connection can be maintained during charging and discharging despite volume changes during charging and discharging caused by the formation of a composite comprising silicon particles and silicon carbide particles. In addition, even if cracks are formed on the surface of the carbon film, it is possible to maintain an electrical connection to the crystalline carbon material such as graphite, graphene, reduced graphene oxide, and graphene oxide, unless the carbon film is completely separated.

[Process for Preparing a Negative Electrode Material for a Lithium-Ion Secondary Battery]

The process for preparing a negative electrode material for a lithium-ion secondary battery according to an embodiment of the present invention comprises (1) thermally decomposing a silicon source gas and a hydrocarbon gas in an inert gas atmosphere at 1,000° C. to 1,500° C. to obtain a thermal decomposition product; (2) depositing the thermal decomposition product as a solid on a precipitation plate to obtain a silicon-silicon carbide composite; and (3) forming a carbon film (carbon layer) on the surface of the silicon-silicon carbide composite.

That is, the silicon-silicon carbide composite may be prepared using a thermal decomposition method by heating in a relatively easy way. It may be obtained by injecting both a silicon source gas and a hydrocarbon gas into a reaction apparatus (reaction furnace) in an inert atmosphere and co-precipitating them on a precipitation plate.

Specifically, in the process for preparing a negative electrode material for a lithium-ion secondary battery, the first step may comprise thermally decomposing a silicon source gas and a hydrocarbon gas in an inert gas atmosphere at 1,000° C. to 1,500° C. to obtain a thermal decomposition product.

The silicon source gas may comprise monosilane gas, disilane gas, or a mixed gas thereof.

As a silane-based gas containing little oxygen is used as the silicon source gas, the silicon-silicon carbide composite obtained based thereon is characterized in that it hardly contains oxygen. In addition, as the silane-based gas is used as a source gas, as described above, a composite having a molar ratio (O/Si) of oxygen atoms to silicon atoms of 0.01 to 0.1 can be obtained.

In addition, the hydrocarbon gas may comprise at least one selected from the group consisting of methane gas, ethane gas, propane gas, butane gas, and ethylene gas.

Meanwhile, a silicon-silicon carbide composite having a desired composition can be obtained by adjusting the ratio of a silicon source gas and a hydrocarbon gas, which can be raw materials for the silicon particles and the silicon carbide particles. In addition, it is characterized in that the silicon source gas is thermally decomposed at a low temperature.

Specifically, the silicon source gas may be fed at 0.5 L/minute to 2 L/minute. In addition, the hydrocarbon gas may be fed at 0.3 L/minute to less than 1 L/minute. For example, the feed ratio (L/minute) of the silicon source gas and the hydrocarbon gas may be 1:0.3 to 1.8, preferably, 1:0.5 to less than 1.

In addition, according to an embodiment of the present invention, the ratio of Si/C atoms in the silicon source gas and the hydrocarbon gas may be 3.0 to 1.0, preferably, 2.5 to 1.0.

In addition, the silicon source gas and the hydrocarbon gas are fed to a preheated reactor, in which the temperature in the reactor may be 1,000° C. to 1,500° C., preferably, 1,000° C. to 1,400° C.

The decomposition temperature of the silicon source gas may be, for example, 300° C. to 500° C., and the decomposition temperature of the hydrocarbon gas may be 500° C. to 900° C. More specifically, the decomposition temperature of monosilane (SiH4) may be 350° C. to 500° C., for example, about 420° C., and that of methane may be 600° C. to 800° C., for example, about 700° C.

Meanwhile, in the first step, nitrogen gas may be fed to obtain silicon carbide having high electrical conductivity. In such a case, a partially nitrided silicon-silicon carbide composite may be formed. Since the silicon nitride is inactive in a lithium-ion secondary battery, the content of nitrogen is preferably 10 ppm to 10,000 ppm.

In the process for preparing a negative electrode material for a lithium-ion secondary battery, the second step may comprise depositing the thermal decomposition product as a solid on a precipitation plate to obtain a silicon-silicon carbide composite.

The precipitation may be carried out by rapidly cooling the thermal decomposition product to room temperature by water cooling. In addition, it may be carried out at room temperature while an inert gas is injected. The inert gas may be at least one selected from carbon dioxide gas, argon (Ar), helium (He), nitrogen (N₂), and hydrogen (H₂).

According to an embodiment of the present invention, the process may further comprise pulverizing and/or classifying the precipitated solid component. The pulverization may be carried out such that the average particle diameter of the solid component is 2 μm to 10 μm. The pulverization may be carried out using a pulverizer or a sieve commonly used. In addition, dry classification, wet classification, or filtration may be used for the classification.

In the process for preparing a negative electrode material for a lithium-ion secondary battery, the third step may comprise forming a carbon film on the surface of the silicon-silicon carbide composite.

The step of forming a carbon film may be carried out by injecting at least one selected from compounds represented by the following Formulae 1 to 3 and carrying out a reaction of the silicon-silicon carbide composite obtained in the second step in a gaseous state at 400° C. to 1,200° C.

CNH_{(2N+2-A)}[OH]_{A} [Formula 1]
in Formula 1, N is an integer of 1 to 20, and A is 0 or 1,

C_{N}H_{(2N-B)} [Formula 2]
in Formula 2, N is an integer of 2 to 6, and B is an integer of 0 to 2,

CₓH_{y}O_{z} [Formula 3]
in Formula 3, x is an integer of 1 to 20, y is an integer of 0 to 25, and z is an integer of 0 to 5.

In addition, in Formula 3, x may be the same as, or smaller than, y

The compound represented by Formula 1 may be at least one selected from the group consisting of methane, ethane, propane, butane, methanol, ethanol, propanol, propanediol, and butanediol. The compound represented by Formula 2 may be at least one selected from the group consisting of ethylene, propylene, butylene, butadiene, and cyclopentene. The compound represented by Formula 3 may be at least one selected from the group consisting of acetylene, benzene, toluene, xylene, ethylbenzene, naphthalene, anthracene, and dibutyl hydroxy toluene (BHT). Specifically, the compound represented by Formula 1 may comprise at least one selected from the group consisting of methane, ethane, propane, and butane. The compound represented by Formula 3 may comprise at least one selected from the group consisting of benzene, toluene, and acetylene.

As a method of forming the carbon film, a carbon film may be formed on the surface of the silicon-silicon carbide composite particles as carbon is chemically deposited in a reducing atmosphere in a temperature range of 700° C. to 1,200° C., preferably, 900° C. to 1,200° C., in an organic gas and/or vapor capable of forming carbon by thermal decomposition.

The chemical vapor deposition can be applied under both normal pressure and reduced pressure. A carbon coating with high uniformity can be obtained up to a deep part by increasing or decreasing the pressure. In addition, commonly known reaction devices, for example, continuous furnaces such as batch furnaces, rotary kilns, and roller hearth kilns and fluidized bed reactors may be used in the process for forming the carbon film

When the silicon-silicon carbide composite is used as a negative electrode material for a lithium-ion secondary battery, a carbon film may be formed on the surface of a composite product obtained through pulverization and/or classification.

In addition, the content of carbon (C) in the carbon film (carbon layer) is as described above.

The carbon source gas, which is a compound represented by Formulae 1 to 3, may further comprise at least one inert gas selected from hydrogen, nitrogen, helium, and argon. In addition, at least one gas selected from water vapor, carbon monoxide, and carbon dioxide may be further added together with the carbon source gas.

The silicon-silicon carbide composite on which a carbon film is formed may have an average particle diameter (D₅₀) of 2 μm to 10 μm. In addition, the average particle diameter (D₅₀) is a value measured as a volume-weighted average particle diameter (D₅₀), i.e., a particle size or median diameter when the cumulative volume is 50% in particle size distribution measurement according to a laser beam diffraction method. Specifically, the average particle diameter (D₅₀) may be preferably 4 μm to 8 μm.

If the average particle diameter (D₅₀) is less than 2 μm, the bulk density is decreased, and the charge and discharge capacity per unit volume may be deteriorated. On the other hand, if D₅₀ exceeds 10 μm, it is difficult to prepare an electrode layer, so that it may be peeled off from the current collector.

In addition, according to an embodiment of the present invention, the process may further comprise pulverizing and classifying the silicon-silicon carbide composite that comprises a carbon film. The classification may be carried out to adjust the particle size distribution of the silicon-silicon carbide composite that comprises a carbon film, for which dry classification, wet classification, or classification using a sieve may be used. In the dry classification, the steps of dispersion, separation, collection (separation of solids and gases), and discharge are carried out sequentially or simultaneously using an air stream, in which pretreatment (adjustment of moisture, dispersibility, humidity, and the like) is carried out prior to the classification so as not to decrease the classification efficiency caused by interference between particles, particle shape, airflow disturbance, velocity distribution, and influence of static electricity, and the like, to thereby adjust the moisture or oxygen concentration in the air stream used. In addition, a desired particle size distribution may be obtained by carrying out pulverization and classification at one time. After the pulverization, it is effective to divide the coarse powder part and the granular part with a classifier or sieve.

The silicon-silicon carbide composite that comprises a carbon film may have an average particle diameter of 2 μm to 5 μm, a Dmin of 0.3 μm or less, and a Dmax of 8 μm to 15 μm, through the pulverization and classification treatment. Within the above ranges, the specific surface area of the composite may be reduced, and the initial efficiency and cycle characteristics may be enhanced by about 10% to 20% as compared with before classification. In particular, if the average particle diameter becomes 2 μm to lam through the pulverization and classification treatment, it is considered that cracks formed in the composite powder are reduced, whereby the matrix is strengthened, and destruction is reduced.

In addition, since the composite powder upon the classification treatment contains amorphous grain boundaries and crystalline grain boundaries, the stress relaxation effect of the amorphous grain boundaries and crystalline grain boundaries can reduce particle destruction in charge and discharge cycles.

The negative electrode material for a lithium-ion secondary battery of the present invention can be prepared using the composite prepared by the preparation process of the present invention as described above.

In addition, the silicon-silicon carbide composite may be used as a negative electrode material for a lithium-ion secondary battery to prepare a negative electrode and a lithium-ion secondary battery.

[Negative Electrode]

According to an embodiment, the present invention may provide a negative electrode, which comprises a negative electrode material for a lithium-ion secondary battery comprising the silicon-silicon carbide composite.

When the negative electrode is prepared, a conductive material comprising carbon or graphite may be added to the negative electrode material in addition to the negative electrode material comprising the silicon-silicon carbide composite. The type of the conductive material is not particularly limited.

The type of the conductive material is not particularly limited as long as it is an electronically conductive material that does not cause decomposition or deterioration in a secondary battery. Specifically, a metal powder or metal fiber such as Al, Ti, Fe, Ni, Cu, Zn, Ag, Sn, and Si, or natural graphite, synthetic graphite, various coke powders, mesophase carbon, vapor-grown carbon fiber, pitch-based carbon fiber, polyacrylonitrile (PAN)-based carbon fiber, and various resin sintered bodies may be used as the conductive material.

The negative electrode material layer (negative electrode active material layer) may be prepared using a composite in which the negative electrode material of the present invention and a carbon-based material are mixed. As a carbon-based material is mixed with a negative electrode material comprising the silicon-silicon carbide composite of the present invention, it is possible to reduce the electrical resistance of the negative electrode material layer and relieve the expansion stress accompanying charging.

The carbon-based material may comprise, for example, at least one selected from the group consisting of natural graphite, synthetic graphite, soft carbon, hard carbon, mesocarbon, carbon fibers, carbon nanotubes, pyrolytic carbon, coke, glass carbon fibers, sintered organic high molecular compounds, and carbon black.

The carbon-based material may be 30% by weight to 90% by weight, preferably, 50% by weight to 80% by weight, based on the total weight of the negative electrode mixture. Here, the negative electrode mixture may comprise a negative electrode material, a binder, and a carbon-based material.

In addition, if silicon particles having a crystallite size of 15 nm or less are used as mixed with graphite-based materials generally having low volume expansion, only the silicon particles do not cause large volume expansion; thus, a lithium-ion secondary battery with excellent cycling characteristics can be obtained since the separation between the graphite-based material and the silicon particles hardly takes place.

The following method may be exemplified as the preparation process of a negative electrode.

A solvent such as N-methylpyrrolidone or water is added to, and kneaded with, the negative electrode material and, if necessary, additives such as a conductive material and a binder such as a polyimide resin to prepare a paste-like mixture. The mixture may be applied to a sheet of a current collector.

Meanwhile, any material for a negative electrode current collector that is commonly used, such as copper foil or nickel foil, may be used as the current collector without limitation in thickness or surface treatment.

The method for molding the mixture onto a sheet is not particularly limited, and a known method can be used.

[Lithium-Ion Secondary Battery]

According to an embodiment of the present invention, the present invention may provide a lithium-ion secondary battery, which comprises a negative electrode comprising the negative electrode material.

Specifically, the lithium-ion secondary battery comprises a negative electrode, a positive electrode, a separator, and a non-aqueous electrolyte, wherein the negative electrode comprises a negative electrode material for a lithium-ion secondary battery, which comprises a silicon-silicon carbide composite comprising silicon particles and silicon carbide particles, wherein the silicon particles and the silicon carbide particles are dispersed with each other in the silicon-silicon carbide composite, the silicon carbide particles are employed in an amount of 10% by weight to 80% by weight based on the total weight of the silicon-silicon carbide composite, and a carbon film is formed on the surface of the silicon-silicon carbide composite.

In addition, if a negative electrode further comprising a carbon-based negative electrode material together with a negative electrode material in which a carbon film is formed on the surface of a silicon-silicon carbide composite comprising silicon particles and silicon carbide particles is used, destruction due to volume change of the negative electrode can be prevented.

The lithium-ion secondary battery according to an embodiment of the present invention is characterized by using a negative electrode material in which silicon particles and silicon carbide particles are dispersed with each other in the silicon-silicon carbide composite, and the silicon carbide particles are employed in a specific content range. In addition, the content of carbon in the form of silicon carbide in the silicon carbide particles can be arbitrarily set. That is, it is possible to arbitrarily change the charge and discharge capacity. In addition, other materials such as the positive electrode, electrolyte, and separator, and the shape of the battery may be known and are not particularly limited.

Specifically, an oxide of a transition metal comprising at least one selected from the group consisting of LiCoO₂, LiNiO₂, LiMn₂O₄, V₂O₅, MnO₂, TiS₂, and MoS₂, lithium, and a chalcogen compound may be used as a positive electrode material used for the positive electrode.

In addition, the lithium-ion secondary battery comprises a non-aqueous liquid electrolyte in which the non-aqueous liquid electrolyte may comprise a non-aqueous solvent and a lithium salt dissolved in the non-aqueous solvent. A solvent commonly used in the field may be used as a non-aqueous solvent. Specifically, an aprotic organic solvent may be used. Examples of the aprotic organic solvent include cyclic carbonates such as ethylene carbonate, propylene carbonate, and butylene carbonate, cyclic carboxylic acid esters such as furanone, chain carbonates such as diethyl carbonate, ethylmethyl carbonate, and dimethyl carbonate, chain ethers such as 1,2-methoxyethane, 1,2-ethoxyethane, and ethoxymethoxyethane, and cyclic ethers such as tetrahydrofuran and 2-methyltetrahydrofuran. They may be used alone or in combination of two or more.

In addition, a lithium salt comprising at least one selected from the group consisting of lithium hexafluorophosphate (LiPF₆) and lithium perchlorate (LiClO₄) may be used as the lithium salt dissolved in the non-aqueous solvent.

In addition, various non-aqueous electrolytes or solid electrolytes used in the art may also be used.

The lithium-ion secondary battery may comprise a separator. The separator may use materials known in the related art.

If the negative electrode material for a lithium-ion secondary battery according to an embodiment of the present invention is applied to a lithium-ion secondary battery, the characteristics of the secondary battery, for example, initial efficiency, charge and discharge capacity, and cycle characteristics can be enhanced. In particular, the initial efficiency and cycle durability can be enhanced.

### MODE FOR THE INVENTION

Hereinafter, the present invention will be described in detail with reference to examples. The following examples are only illustrative of the present invention, and the scope of the present invention is not limited thereto.

### Example 1

<Preparation of a Negative Electrode Material>

A mixed gas of 1.0 L/minute of monosilane and 0.5 L/minute of methane gas was fed to a reactor sufficiently purged with nitrogen and heated at 1,250° C. in advance, in which the gas stream was directed to a precipitation plate installed in the reactor as a target. Upon reaction for 1 hour, the mixture was cooled while being purged with nitrogen again to obtain about 90 g of a grayish-black solid (precipitate) deposited on the precipitation plate. The solid was crushed and then pulverized with a ball mill (Daecheong) for 4 hours to obtain silicon-silicon carbide composite particles.

g of the silicon-silicon carbide composite particles thus obtained was placed in a tubular electric furnace and reacted at 1,000° C. for 3 hours while a mixed gas of methane and argon flowed at a rate of 1 L/minute, respectively, to obtain a composite having a particle size (D₅₀) of 3.5 μm in which a carbon film was formed on the surface of the silicon-silicon carbide composite.

<Preparation of a Negative Electrode>

The silicon-silicon carbide composite particles with a carbon film formed thereon were used as a negative electrode material to fabricate a lithium-ion secondary battery.

First, the silicon-silicon carbide composite particles with a carbon film formed thereon and synthetic graphite (average particle diameter of 10 μm) were mixed at a weight ratio of 50:50 using a vibrating mill. The mixed negative electrode material and a polyimide-based binder were mixed at a weight ratio of 90:10. Added thereto was N-methyl pyrrolidone, which was subjected to shear mixing using a sinky-mixer to obtain a negative electrode slurry.

The slurry was coated onto a copper foil having a thickness of 12 μm and dried at for 1 hour. Then, an electrode was prepared by pressure-molding using a roller press. The electrode was thermally treated at 200° C. for 1 hour in an argon atmosphere. Thereafter, it was punched to 16 mmφ to prepare a negative electrode.

### Example 2

A composite having an average particle diameter (D₅₀) of 3.8 μm with a carbon film formed on the surface of a silicon-silicon carbide composite (solid (precipitate) of about 94 g) and a negative electrode were obtained in the same manner as in Example 1, except that a mixed gas of 1.0 L/minute of monosilane gas and 0.6 L/minute of methane gas was used.

### Comparative Example 1

A composite having an average particle diameter (D₅₀) of 3.4 μm with a carbon film formed on the surface of a silicon-silicon carbide composite (solid (precipitate) of about 105 g) and a negative electrode were obtained in the same manner as in Example 1, except that a mixed gas of 1.0 L/minute of monosilane gas and 1.0 L/minute of methane gas was used.

### Comparative Example 2

A solid of about 89 g was obtained in the same manner as in Example 1, except that a mixed gas of 1.0 L/minute of monosilane gas and 0.25 L/minute of acetylene gas was used, the reaction temperature changed to 850° C. to obtain silicon-silicon carbide composite particles, and a carbon film was not formed on the surface of the particles. Thereafter, the solid was crushed and then pulverized with a ball mill (Daecheong) for 4 hours to obtain a silicon-silicon carbide composite having an average particle diameter (D 50) of 2.9 μm and a negative electrode.

### Comparative Example 3

A solid of about 95 g was obtained in the same manner as in Comparative Example 2, except that a mixed gas of 1.0 L/minute of monosilane gas and 0.3 L/minute of acetylene gas was used. Thereafter, the solid was crushed and then pulverized with a ball mill (Daecheong) for 4 hours to obtain a silicon-silicon carbide composite having an average particle diameter (D₅₀) of 3.0 μm and a negative electrode.

### Test Example

### Test Example 1: Measurement of Carbon Content

The content of carbon in the silicon-silicon carbide composite particles was measured using a combustion-infrared absorption method carbon analyzer in accordance with JIS R 2011:2007. The content of the entire carbon is measured by adding tin powder as a combustion aid, and the content of free carbon is measured without adding a combustion aid.

### Test Example 2: Analysis of the Performance of a Lithium-Ion Secondary Battery

To evaluate the electrochemical properties, a metal lithium foil having a thickness of 0.3 mm was used as a counter electrode. A non-aqueous electrolyte, in which LiPF₆ was dissolved at 1 M in a solution of ethylene carbonate (EC) and diethylene carbonate (DEC) mixed at a ratio of 1:1 (volume ratio), was used as an electrolyte. In addition, a porous polyethylene separator with a thickness of 30 μm was used to fabricate a coin cell.

The coin cell thus fabricated was aged overnight at room temperature. Then, the coin cell was charged at a constant current of 0.5 mA/cm² until the voltage reached 0 V and then at a constant voltage until the current reached 40 μA/cm² and discharged at a constant current of 0.5 mA/cm² until the voltage reached 1.5 V using a charge and discharge test device (WonA Tech).

The content of the components of the negative electrode materials prepared in the Examples and Comparative Examples and the performance analysis results of the lithium-ion secondary batteries are shown in Tables 1 and 2 below.

TABLE 1

| | | | | | Silicon-silicon carbide |
|---|---|---|---|---|---|
| | | | | | composite with a |
| | | | | | carbon film formed |
| | Silicon-silicon carbide composite | | | | Total content of free |
| | Content of the | Content of | Content of carbon | SiC | carbon and carbon |
| | entire carbon | free carbon | in the form of SiC | (% by | contained in the carbon |
| | (% by weight) | (% by weight) | (% by weight) | weight) | film (% by weight) |
| Ex. 1 | 18.4 | 0.5 | 17.9 | 59.7 | 3.5 |
| Ex. 2 | 20.8 | 0.5 | 20.3 | 68.7 | 3.5 |
| C. Ex. 1 | 30.1 | 0.5 | 29.6 | 98.6 | 3.6 |
| C. Ex. 2 | 17.6 | 17.3 | 0.3 | 0.3 | 17.30 |
| C. Ex. 3 | 20.4 | 20.1 | 0.3 | 0.3 | 20.1 |

TABLE 2

| | Performance evaluation of secondary battery | | |
|---|---|---|---|
| | Initial efficiency | First discharge | Capacity retention rate |
| | (%) | capacity (mAh/g) | upon 50 cycles (%) |
| Ex. 1 | 91 | 922 | 91 |
| Ex. 2 | 91 | 742 | 92 |
| C. Ex. 1 | 91 | 370 | 90 |
| C. Ex. 2 | 89 | 910 | 25 |
| C. Ex. 3 | 90 | 715 | 35 |

Referring to Tables 1 and 2, the performance of the lithium-ion secondary batteries of Examples 1 and 2 of the present invention was significantly enhanced overall as compared with the lithium-ion secondary batteries of Comparative Examples 1 to 3.

Specifically, the lithium-ion secondary batteries of Examples 1 and 2, in which silicon carbide particles were contained in an amount of 59.7% by weight or 68.7% by weight based on the total weight of the silicon-silicon carbide composite, were significantly enhanced in initial efficiency, initial discharge capacity, and capacity retention rate upon 50 cycles as compared with the lithium-ion secondary batteries of Comparative Examples 1 to 3, in which silicon carbide particles were contained in an amount of 98.6% by weight or 0.3% by weight based on the total weight of the silicon-silicon carbide composite.

On the other hand, in the lithium-ion secondary battery of Comparative Example 1 in which silicon carbide particles were contained in an amount of 98.6% by weight based on the total weight of the silicon-silicon carbide composite, the initial discharge capacity was significantly reduced as compared with the lithium-ion secondary batteries of the Examples. In the lithium-ion secondary batteries of Comparative Examples 2 and 3 in which silicon carbide particles were contained in a minute amount of 0.3% by weight based on the total weight of the silicon-silicon carbide composite, the capacity retention rate upon 50 cycles was significantly reduced.

Accordingly, it was confirmed that the performance of a lithium-ion secondary battery can be enhanced by controlling the content of silicon carbide particles based on the total weight of the silicon-silicon carbide composite.

1. A negative electrode material for a lithium-ion secondary battery, which comprises a silicon-silicon carbide composite comprising silicon particles and silicon carbide particles,
wherein the silicon particles and the silicon carbide particles are dispersed with each other in the silicon-silicon carbide composite,
the silicon carbide particles are employed in an amount of 10% by weight to 80% by weight based on the total weight of the silicon-silicon carbide composite, and
a carbon film is formed on the surface of the silicon-silicon carbide composite.

2. The negative electrode material for a lithium-ion secondary battery of claim 1, wherein the silicon particles have a crystallite size of 1 nm to 15 nm.

3. The negative electrode material for a lithium-ion secondary battery of claim 1, wherein the silicon carbide particles are crystalline with a crystallite size of 1 nm to 50 nm, amorphous, or a combination thereof.

4. The negative electrode material for a lithium-ion secondary battery of claim 1, wherein the silicon carbide particles comprise carbon in the form of silicon carbide and free carbon.

5. The negative electrode material for a lithium-ion secondary battery of claim 1, wherein the content of carbon (C) contained in the carbon film is 2% by weight to 25% by weight based on the total weight of the silicon-silicon carbide composite comprising the carbon film.

6. A process for preparing the negative electrode material for a lithium-ion secondary battery of claim 1, which comprises:
(1) thermally decomposing a silicon source gas and a hydrocarbon gas in an inert gas atmosphere at 1,000° C. to 1,500° C. to obtain a thermal decomposition product;
(2) depositing the thermal decomposition product as a solid on a precipitation plate to obtain a silicon-silicon carbide composite; and
(3) forming a carbon film on the surface of the silicon-silicon carbide composite.

7. The process for preparing the negative electrode material for a lithium-ion secondary battery according to claim 6, wherein the silicon source gas in step (1) comprises monosilane gas, disilane gas, or a mixed gas thereof.

8. The process for preparing the negative electrode material for a lithium-ion secondary battery according to claim 6, wherein the hydrocarbon gas in step (1) comprises at least one selected from the group consisting of methane gas, ethane gas, propane gas, butane gas, and ethylene gas.

9. The process for preparing the negative electrode material for a lithium-ion secondary battery according to claim 6, wherein the ratio of Si/C atoms in the silicon source gas and the hydrocarbon gas is 3.0 to 1.0.

10. The process for preparing the negative electrode material for a lithium-ion secondary battery according to claim 6, wherein the formation of the carbon layer in step (3) is carried out by injecting at least one selected from compounds represented by the following Formulae 1 to 3 and carrying out a reaction in a gaseous state at 400° C. to 1,200° C.:
C_{N}H_{(2N+2-A)}[OH]_{A} [Formula 1]
in Formula 1, N is an integer of 1 to 20, and A is 0 or 1,
C_{N}H_{(2N-B)} [Formula 2]
in Formula 2, N is an integer of 2 to 6, and B is an integer of 0 to 2,
CₓH_{y}O_{z} [Formula 3]
in Formula 3, x is an integer of 1 to 20, y is an integer of 0 to 25, and z is an integer of 0 to 5.

11. A lithium-ion secondary battery, which comprises the negative electrode material for a lithium-ion secondary battery of claim 1.
